(19) United States
(12) Patent Application Publication
(10) Pub. No.: US 2001/0049661 A1
(43) Pub. Date: Dec. 6, 2001

(54) Method for interactive advertising on the internet

(75) Inventors: John Casey Power, Carefree, AZ (US); Kenneth Wayne Wilson, Mesa, AZ (US)

Correspondence Address: John C. Power, 8538 Dog Leg Drive, P.O. Box 3458, Carefree, AZ, 85377, US

(73) Assignee: John Casey Power

(21) Appl. No.: 09/750,613

(22) Filed: Dec. 28, 2000

Related U.S. Application Data
(60) Provisional application No. 60/197,627, filed on Apr. 17, 2000.

(51) Int. Cl. G06F 17/60; H04K 1/00; H04L 9/00

(52) U.S. Cl. 705/51; 705/14

(57) ABSTRACT

The present invention significantly enhances the value that can be provided to a sponsor of a website, thus generating increased revenue for the website host or owner. In accordance with the present invention, when an Internet user attempts to access a website or a page of a website from a computer terminal, the user is presented with a text and/or audio message appearing on his computer screen informing the user that the site is sponsored and that, to gain access to the website or web page, the user must either type or speak a sponsor access word. The user is then provided the desired access word via the same text or audio message or by a subsequently appearing text and/or audio message. Upon providing the access word, the user is granted access to the website or specific web page. Alternatively, the user obtains access to the site by performing some other action that is related to acknowledging the sponsor's products or corporate identity, such as answering a survey question, playing a game or performing any other promotional request.

### FIELD OF THE INVENTION

The present invention relates in general to the field of technology associated with the Internet, Intranet, Extranet, Virtual Private Networks (VPNs), and all related predecessors and successors of World Wide Web technology, and, more particularly, to the field of online advertising and sponsorship.

### BACKGROUND OF THE INVENTION

Presently, Internet website hosts, owners and service providers use three primary methods for generating revenue. The first method is direct e-commerce, that is, the direct selling of goods and services on a website. For every sale of a product or service made on a website, the website host or owner may receive a transaction/service fee or royalty from the product or service provider.

The second method of generating revenue on the Internet includes subscription or fee-based access to websites. For example, subscribers may typically pay a monthly or annual membership fee to access a specific website or portal. This method is primarily used for business-to-business commerce, but is beginning to develop on a business-to-consumer basis.

The third method of generating revenue is through advertising on the website. The most predominant method of advertising in the Internet is through banner advertising, which is typically sold on a “cost-per-impression” or “cost-per-click-through” basis. With banner advertising, an advertiser typically pays a website host or owner an agreed upon fee each time its banner advertisement is displayed on a website. However, with the proliferation of the Internet and its increased usage, websites typically contain several banners on each webpage thereby diluting the effectiveness of each advertisement and even leading to the risk that a particular banner is ignored or overlooked in view of the many others that appear in close proximity thereto. Accordingly, many advertisers have chosen to pay a fee to the web host only when a user actually clicks on the banner advertisement and is linked to the advertiser's website. However, this arrangement between the host and advertiser will inherently generate a decreased amount of revenue for the website owner thereby making it difficult for such websites to sustain themselves.

Sponsorship has developed as an alternative method for generating revenue for websites via advertising. Through sponsorship, a website host or owner, for a fee, provides sponsors with prominent placement of their logo or product on a given website. However, because of the passive nature of the advertisement, i.e., a user can choose to quickly click through one or more webpages without allowing proper time for the entire webpage to download or without really viewing what was intended to be displayed, even with prominent placement, the advertisement is often ignored.

Hence, a need exists for an improved method for providing advertisement on the Internet that does not suffer from the disadvantages described above and ensures that the advertisement is actually being read and acknowledged by users of the Internet.

### SUMMARY OF THE INVENTION

The purpose of the present invention is to significantly enhance the value that can be provided to a sponsor of a website, thus generating increased revenue for the website host or owner. In accordance with the present invention, when an Internet user attempts to access a website or a page of a website from a computer terminal, the user is presented with a text and/or audio message appearing on his computer screen informing the user that the site is sponsored by a particular entity and that to gain access to the website or web page the user must either type or speak sponsor access information. The user is then provided the desired access word or phrase via the same text or audio message or by a subsequently appearing text and/or audio message. Upon providing the access information, the user is granted access to the website or specific web page. Alternatively, the user obtains access to the site by performing some other action that is related to acknowledging the sponsor's products or corporate identity, such as answering a survey question, playing a game or performing any other promotional request.

The program suitably interrogates the entered access word and performs various access word functions which are known in the art, including the transmission of certain access words to the host server or a sponsor's server. Once the user types the access word into the access word entry page and the access word is approved, the user receives access to the site or, optionally, sees a short commercial before entering the site.

The present invention provides advantages over previous Internet advertising methods. Using the present invention, sponsorship becomes interactive instead of passive. Rather than merely viewing a logo or product on the website, which in many cases is ignored or not even given adequate time to completely download, the user must type predetermined access information such as a desired product, service or brand name to gain access to the website. Consequently, the user becomes more aware of the sponsor and is more likely to positively receive visual or text content about the sponsor of the website. Further, a user's perceived value is greater for password-protected websites. Thus, the user believes the information being obtained is of greater value, enhancing the value of the website and the sponsorship. Moreover, the website host or provider may choose not to display any additional advertising on the website, thus increasing the perceived integrity of the website.

The sponsor can pay for advertising on a per-access word basis, that is, the sponsor would pay the content provider or website host for each user that actually types in the desired access word and obtains access to the site. Because people learn and remember by writing and saying information, as opposed to merely viewing the information, this process is more valuable to the sponsor than a banner advertisement or traditional sponsorship. However, it is understood that the present invention may be implemented in conjunction with these other forms of advertising.

Additionally, profiling can be used to supplement the present invention by enabling website owners to target specific sponsor advertising information based on preferences of the user. This increases even further the relevance of the advertising, and coupled with user acknowledgement via a password, the present invention provides the most advanced online advertising and sponsorship system.

### BRIEF DESCRIPTION OF THE DRAWINGS

FIG. 1 is a high-level flowchart illustrating a process associated with an interactive advertising system on the Internet in accordance with the present invention;

FIG. 2 is a more detailed flowchart illustrating a process associated with an interactive advertising system on the Internet that incorporates user profiles to enhance an interactive advertising system of FIG. 1;

FIG. 3 is a flowchart illustrating a process associated with handling mistyped or misspoken passwords in an interactive advertising system of FIG. 1;

FIG. 4 is a flowchart illustrating a process associated with password validation whether typed or spoken; and

FIG. 5 is a flowchart illustrating a process associated with the use of other interactive methods for users to acknowledge website sponsors.

### DETAILED DESCRIPTION OF THE DRAWINGS

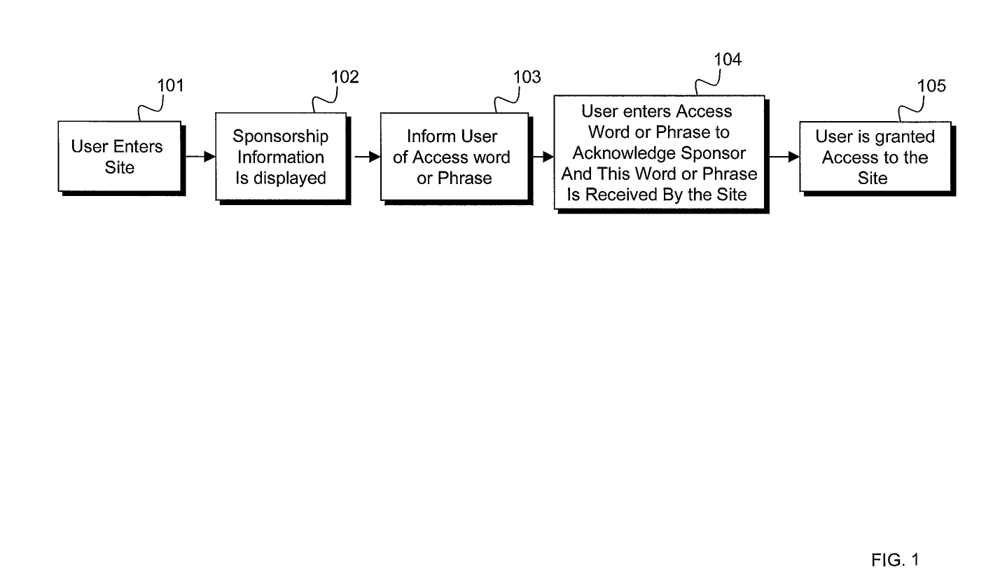

The present invention provides an interactive process for conveying information about sponsors and other advertisers on a website, and having users acknowledge them by taking some appropriate action before they can access the website. As shown in FIG. 1, a high-level flowchart illustrating an embodiment of the present invention is depicted. In Step 101, a user enters the website using a standard web browser and standard web navigation techniques. Prior to entering the website to view content, information about the identity of the sponsor for that website is transmitted to the user for display on a terminal associated with the user (Step 102). Other information may be transmitted to the user such as identification or information relating to the products endorsed by the sponsor. This information can be presented as written text on a computer screen, as a commercial using standard Internet media techniques, as spoken words in a sound file, or any other means by which sponsorship information can be conveyed to the user. Accordingly, this information may be text, sound or image information whereby the imaging information may include, for example, video information, graphical information or the like. At some point in the conveyance of information about the sponsor, the user is informed of a required keyword, password or other such access information (e.g., a word or phrase) that must be types in order to gain access to the website (Step 103). The conveyance of such access word or phrase does not necessarily need to be in the same format as that which is used to present the sponsorship information. For example, information about the sponsor could be conveyed to the user in a sound file, however the access word or phrase could be presented to the user as written text on the computer screen. In other cases, an access word or phrase may not be specifically identified as such to the user. In such cases, the user obtains access to the site by performing some other action that is related to acknowledging the sponsor's products, services or corporate identity, such as answering a survey question, playing a game or performing any other promotional request. In step 104, the user enters the access word or phrase to acknowledge the sponsor and/or its advertisement and this user entered data is received by the website for validation. The entering of the access word or phrase may be performed in a number of ways such as, for example by typing in the keyword or phrase into the appropriate section of the presented screen, by speaking the keyword or phrase into a microphone attached to the user's computer system, by successfully performing any number of interactive steps, such as answering a survey question, playing a game or performing any other promotional request, or by performing some other action that enables users to provide input to a computer and have such input be conveyed accordingly to the website. Assuming the user responded successfully by entering in the correct access word or phrase, the user is then granted access to the website and is delivered the requested web page (Step 105).

By way of example, a user requests entry to a given website and a typical text or audio message is transmitted to the user that may include, for example, the following information: “Company X is today's sponsor of this website. You may enter this site as their guest by typing today's access information which is ‘Product Y’” (wherein Product Y is typically manufactured, distributed or sold by Company X). Although the access information can be any word or phrase, in a preferred embodiment of the present invention the access information would be related to a product, service or identity of the sponsor. A typical access word entry page subsequently appears on the user's computer screen and the user is prompted or notified in some fashion to input such access information which is eventually sent to and received by the website server. Assuming that this is the proper access information, the user is granted access to the requested website. One skilled in the art will appreciate that any suitable password or access information program can be incorporated into the present invention such as, for example, the WEBSTAR™ password product. However, unlike typical passwords, which are often case sensitive and require the password to be typed with certain capitalized or lower-case letters, the access information of the present invention is not so limited. In addition, while most password programs do not show the typed-in password on the screen for security reasons, the access information of the present invention would be displayed.

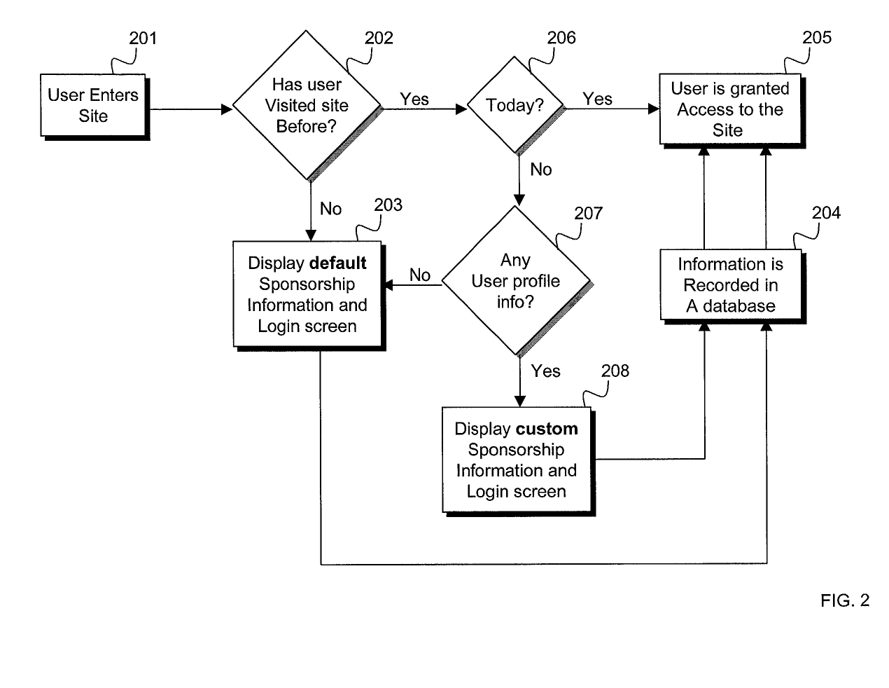

FIG. 2 is flow chart providing further detail to the flow chart of FIG. 1. More particularly, FIG. 2 illustrates the process of incorporating user profiles to determine what type of sponsorship information should be displayed in Steps 102 and 103 above. In Step 201, the user enters the website. Upon entering the website, information about the user is used to determine whether or not the user has previously visited the website (Step 202). Information about the user can be obtained through the use of “cookies”, through some previous action, such as a user login process, or through other similar actions and/or processes that can be used to differentiate one user from another.

If it has been determined through computer software running on the web server, or other computer associated with said web server, that the user has not previously visited the site, then the web server will present the “default” sponsorship information to the user, using the default method of conveyance (Step 203). Given that the user hasn't previously visited the website, there would exist no specific profile or preference information about the user. Thus, presenting any sponsorship information other than the “default” would result in a “guess” about what sponsor would be best aligned with the preferences of that user. A likely “default” sponsor would be one whose business products and/or services pertained to a broad audience.

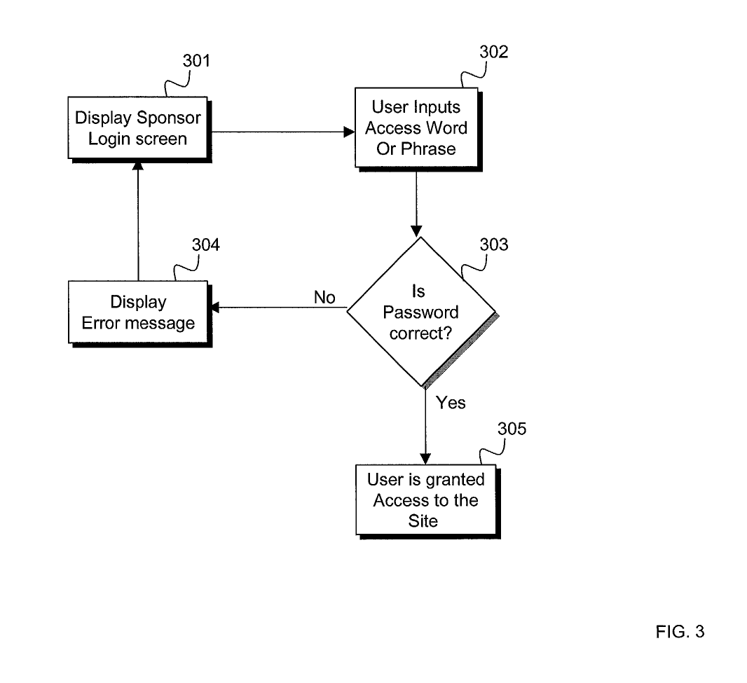

Provided the user has responded appropriately to the actions called for in Step 203, information is recorded in a database (Step 204) and the user is granted access to the website (Step 205). Appropriate response from the user includes providing the necessary assess word or phrase, or other response required by the sponsor; this user action is further defined below in this specification pertaining to FIG. 3. The information recorded in the database will typically include, for example, the actions taken by the user during this specific interactive sponsorship process, and records information that will be used in later and subsequent sessions to determine if the user has been to the website before. Specifically, information such as “success” or “failure”, date and time of access, and identification information are examples of information that may be recorded in the database. Information about the user's preferences and website usage patterns are obtained and recorded in a database after obtaining access to the website. Such preference gathering and profiling is well-known in the art and is not within the scope of the present invention.

Referring back to Step 202, if it has been determined that the user has been to the website previously, then, optionally, a determination can be made if such previous visits included an earlier visit on the same day as the current day (Step 206). The website owner may wish to limit the number of times a user has to acknowledge the website's sponsor to once per day. This would be conducive to a “Sponsor-of-the-Day” program. Thus, if it were determined that the user had previously visited the site earlier in the day, then the user would be provided immediate access to the website without having to provide further sponsor acknowledgement. If, however, it was determined that previous visits did not include a same-day visit, or if optional Step 206 was not used in the embodiment, then a determination would be made whether or not any user profile information exists (Step 207). The existence of any user profile information may be made through the use of specially configured, custom software running on the web server, or other associated computer, and would typically involve searching and retrieving information from a database.

If it is determined in Step 207 that no user profile information exists, then the “default” sponsorship information is displayed (Step 203) and the process continues as previously described. If profile information does exist, then “custom” sponsorship information is displayed (Step 208). Custom sponsorship information is basically information that is tailored for a particular user based on preferences, knowledge or past history of such user. Such custom information may be generated by a process, which is facilitated through the use of specially configured, custom software running on the web server, or other associated computer, to match up the user with an appropriate sponsor, where said sponsor's business products and/or services align with the preferences of said user. Further, in instances where it is determined that more than one sponsor has products and/or services that align with said user preferences, which sponsor gets displayed can be determined by said software in a number of ways, such as:

A rating system could be employed to rate the relevance of user preferences to the sponsor's products and/or services. In other words, where two or more sponsors are relevant, which has the most relevance to the user's preferences?

A counting system could be employed to determine the number of times each sponsor's information has been displayed to said user. The sponsor with the lowest count would be displayed.

A random system could be employed that would simply chose which sponsor's information is displayed.

A fee-based system could be employed as a stand-alone system or in combination with a random system. Thus, which sponsor's information was displayed would be related to how much money was paid to the website's owner.

Once the user has responded appropriately to the actions required by Step 208, information is recorded in a database (Step 204) and the user is granted access to the website (Step 205).

An important aspect associated with the embodiment of FIG. 2 includes the use of a database to store user profiles and a process by which these profiles can be retrieved, updated, processed, and/or evaluated whereby such process is facilitated through the use of specifically configured software designed for such purpose.

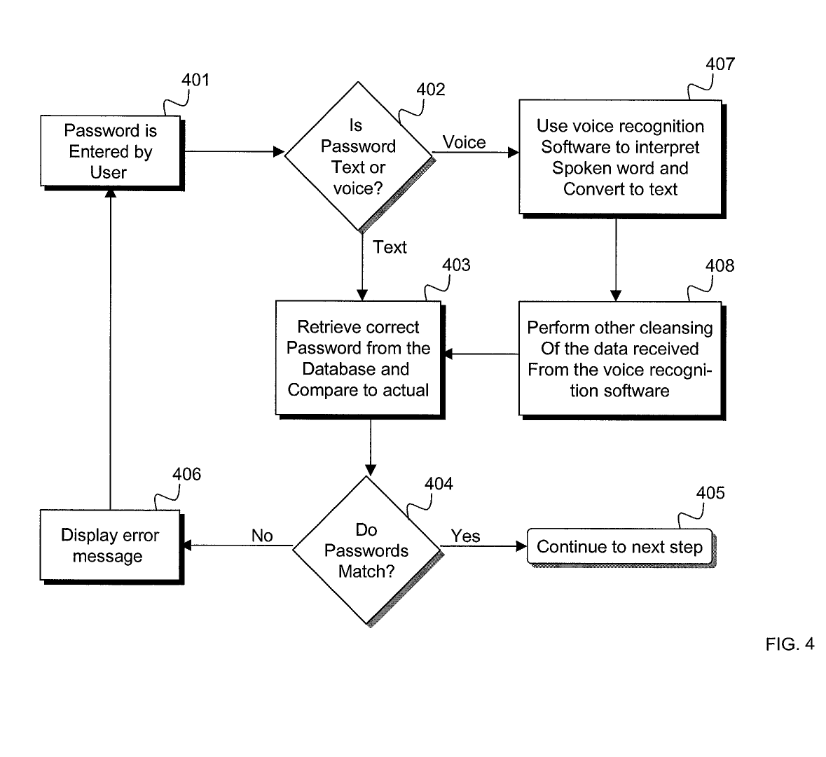

In FIG. 3, a flowchart is presented to illustrate a process associated with handling mistyped or misspoken passwords in an interactive advertising system of FIG. 1. In the first step (Step 301), the sponsor information is displayed. If the actions of Step 301 call for the users to input an access word or phrase, the user does so (Step 302). As aforementioned, the inputting of the access word or phrase may be performed in a number of ways such as, for example by typing in the keyword or phrase into the appropriate section of the presented screen, by speaking the keyword or phrase into a microphone attached to the user's computer system, by successfully performing any number of interactive steps, such as answering a survey question, playing a game or performing any other promotional request, or by performing some other action that enables users to provide input to a computer and have such input be conveyed accordingly to the website. A determination is made whether or not the access word or phrase is correct (Step 303). This determination is made using software that is specially configured and customized for this purpose. The process for making this determination is described in further detail below, in association with FIG. 4.

If the access word or phrase is not correct, an error message is displayed to the user (Step 304) and the sponsor information is displayed again (Step 301) and the process repeats. Optionally, if the user fails to enter the correct access word or phrase repeatedly, the user may be granted access to the website after a predetermined number of failed attempts have been made. In a more restrictive posture, the website owner may optionally decide to deny access to the website after a predetermined number of failed attempts have been made.

Referring back to Step 303, if the user entered the required access word or phrase correctly, then the user is granted access to the website (Step 305).

FIG. 4 describes a process associated with determining whether or not the user entered the correct access word or phrase. In the first step (Step 401), the user enters the access word or phrase. This step may be performed in a number of ways as was previously mentioned with respect to step 104 of FIG. 1 and step 302 of FIG. 3. In embodiments of the present invention which facilitate the input of access word or phrase through textual and/or vocal means, a determination is made whether said access word or phrase is textual or vocal (Step 402). Some embodiments of the present invention may provide the option for the user to type in the access word or phrase, or to speak it into a microphone connected to the user's computer, while other embodiments restrict input to a single type. If the input is textual, validation is performed on said input by retrieving the correct access word or phrase from a database and comparing it to the input provided by the user (Step 403). The database access and comparison are performed using specially configured, custom software designed for this purpose.

A determination is made whether or not the inputted access word or phrase matches the correct access word or phrase (Step 404). If a match exists, then processing continues to the next step (Step 405). The next step may be Step 105 in FIG. 1 or Step 204 in FIG. 2. If a match does not exist between the inputted and the correct access words or phrases, then an error message is display to the user (Step 406) and the user is asked to input the access word or phrase again (Step 401) and the process repeats. Optionally, if the user fails to enter the correct access word or phrase repeatedly, the user may be granted access to the website after a predetermined number of failed attempts have been made. In a more restrictive posture, the website owner may optionally decide to deny access to the website after a predetermined number of failed attempts have been made.

Referring back to Step 402 of FIG. 4, if the user inputs the access word or phrase using a microphone attached to the user's computer, then voice recognition software would be invoked to analyze the spoken word or phrase and convert it to text (Step 407), as is well known in the art. The voice recognition software may either run on the user's computer, or be other specially configured, custom software running on the user's computer that would transmit the sound file to the web server for processing. In the latter instance, the process could be facilitated through the use of JAVA, ActiveX® or other such web technologies.

Other cleansing of the data outputted from the voice recognition software would be performed (Step 408). Such cleansing could include text formatting and language translations. Once the data has been further cleansed, the validation process described in Step 403 is invoked and the subsequent processes described previously continue.

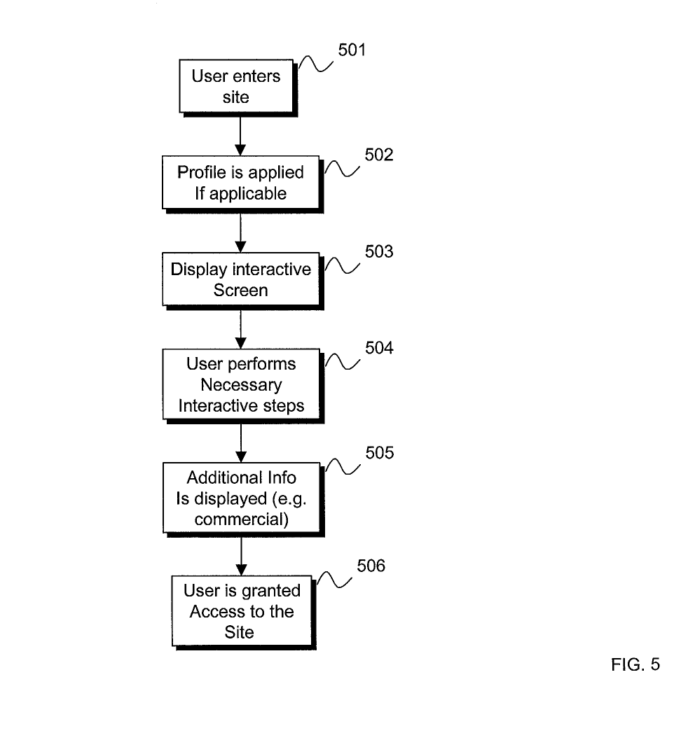

FIG. 5 is a flowchart illustrating a process associated with the use of other interactive methods for users to acknowledge website sponsors. Such methods include requiring the user to perform some other action that is related to acknowledging the sponsor's products or corporate identity, such as answering a survey question, playing a game or performing any other promotional request. Such methods may also include displaying a commercial or other information about the sponsor after the user has correctly entered the access word or phrase, but prior to being given access to the website. In the first step of FIG. 5 (Step 501), the user enters the website. Similar to step 207 of FIG. 2, user profile information may be optionally applied to determine the correct sponsor (Step 502). Next, an interactive screen, or set of screens, is displayed to the user (Step 503). The screen(s) could be in the form of a survey, game or other promotional process. The screen or set of screens provides an interface between the user and the interactive process required by the sponsor. This process is facilitated through the use of specially configured, custom software running on the web server, user computer, or other associated computer. In Step 504, the user successfully performs the interactive process by filling out or otherwise completing the screen(s) presented in the previous step. Optionally, the user is provided other information about the sponsor, such as a commercial, coupons, rebates, or other visual, audio or textual information (Step 505); this information does not require further input from the user. Once completed, the user is granted access to the website (Step 506).

It is believed that this invention will, for the first time, enable sponsors and advertisers to make use of the highly interactive medium that the Internet presents in such a way as to increase the relevance and meaningfulness of advertisements and provide them with more positive feedback that their advertisements are actually being viewed, paid attention to and even acknowledged.

While several embodiments of the present invention are described, it is contemplated that various modifications may be made thereto without departing from the spirit and scope of the present invention. Accordingly, it is intended that the embodiments described are considered only as illustrative of the invention and that the scope of the invention be determined by the claims hereinafter provided.

What is claimed is:

1. A method for providing advertisement on the internet, comprising the steps of:
receiving a request from a user to access a website;
transmitting information to said user including sponsor information associated with a sponsor of said website;
informing said user of access information for use in accessing said website;
receiving information from said user; and
granting said user access to said website if said information received from said user matches said access information.

2. The method of claim 1 wherein said access information is related to a product of said sponsor.

3. The method of claim 1 wherein said access information is related to a service of said sponsor.

4. The method of claim 1 wherein said access information is information related to an identification of said sponsor.

5. The method of claim 1 wherein said step of transmitting information to said user includes transmitting information that is selected based on a profile of said user.

6. The method of claim 1 wherein said information received from said user is text data.

7. The method of claim 1 wherein said information received from said user is audio data.

8. The method of claim 7 wherein said step of granting said user access includes the substep of converting said information received from said user from said audio data to text data.

9. The method of claim 1 wherein said step of transmitting information to said user includes transmitting information to provide an interface between said user and an interactive process required by said sponsor.

10. The method of claim 9 wherein said interactive process includes requiring said user to complete a survey.

11. The method of claim 9 wherein said interactive process includes requiring said user to play a game.

12. The method of claim 1 further including the step of transmitting additional information to said user after receiving said information from said user.

13. The method of claim 1 wherein said sponsor information includes audio information.

14. The method of claim 1 wherein said sponsor information includes imaging information.

15. A method for providing advertisement on the internet, comprising the steps of:
receiving a request from a user to access a website;
determining whether said user has previously accessed said website;
transmitting information to said user for display on a computer terminal associated with said user, said information being associated with a sponsor of said website and said information including access information for use in accessing said website and a prompt to said user to input said access information;
receiving information from said user;
determining whether said information received from said user matches said access information; and
granting said user access to said website if said information received from said user matches said access information.

16. The method of claim 15 wherein said step of determining whether said user has previously accessed said website includes the substep of determining whether said user has accessed said website on a same day as a day that said request is received.

17. The method of claim 16 wherein said user is allowed immediate access to said website and without transmitting said information associated with said sponsor to said user if said user has accessed said website on said same day as said day that said request is received.

18. The method of claim 15 wherein said information received from said user includes audio data and said step of determining whether said information received from said user matches said access information includes:
converting said audio data to text data, and
comparing said text data with said access information.

19. The method of claim 15 further including the step of recording actions taken by said user thereby generating a profile for said user.

20. The method of claim 15 wherein a profile of said user is used to provide specific sponsorship information to said user.

21. The method of claim 15 wherein said access information is related to a product of said sponsor.

22. The method of claim 15 wherein said access information is related to a service of said sponsor.

23. The method of claim 15 wherein said access information is information to an identification of said sponsor.
